(19) United States
(12) Patent Application Publication
(10) Pub. No.: US 2006/0155569 A1
(43) Pub. Date: Jul. 13, 2006

(54) Style trend tracking tool

(76) Inventors: Judd A. Lord, Carmel, IN (US); Emilie A. Williams, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 11/328,336

(22) Filed: Jan. 9, 2006

Related U.S. Application Data
(60) Provisional application No. 60/642,355, filed on Jan. 7, 2005.

(51) Int. Cl. G06Q 99/00; G07G 1/14; G06Q 30/00

(52) U.S. Cl. 705/1; 705/14

(57) ABSTRACT

A system and a method are provided for mapping a portfolio of products.

### BACKGROUND AND SUMMARY OF THE INVENTION

This application claims the benefit of U.S. Provisional Application Ser. No. 60/642,355, filed Jan. 7, 2005, which is expressly incorporated by reference herein.

The present invention relates to a style and trend tracking tool for use in new product development. More particularly, the present invention relates to a software tool which is useful to an industrial designer or other product developer to assist with the design process.

The present improves the new product development process, especially the ‘fuzzy’ front end, by providing a framework for inspiring product aesthetic and function direction for a company's portfolio. The tool of the present invention is also useful for product marketing.

The system and method of the present invention illustratively permits a company to do at least the following activities:

Map competitive product portfolios vs. current trends

Compare its portfolio vs. the competition

Compare products sold at specific price points

Compare products sold at specific retailers

Easily identify new product opportunities

Map the company's product portfolio vs. current trends

Prompt investigation of potential opportunities

Map current trends vs. historical, absolute design cues

Map portfolios over time and review product trends

Aid in creating a common design language within new product marketing groups (puts everyone on same page)

Provides flexibility for updating a trend map (every 1st & 3rd quarters min)

Provides flexibility for updating portfolio maps on continuous basis

The style and trend tracking system and method of the present invention is illustratively built in four layers. It is understood, however, that fewer layers may be used in certain embodiments and that the layers may be based on other criteria. In the illustrative example, such as for a household item, the layers include:

1. A Foundation Layer—The foundation layer is derived from historical design cues, current housing stock, and current interior and exterior home preferences.

2. A Trends Layer—The trends layer is derived from current trends identified via internal and outside sources, trend and trade show reports, internet and periodical research, etc.

3. A Price Continuum Layer—The price continuum layer is based on products currently stocked at retail locations (non special order items).

4. A Product Mapping Layer—This mapping layer maps company and competitive product portfolios as an overlay on the other layers.

Although the illustrated embodiment of the invention is described in connection with product mapping for household items, it is understood that other products may be mapped in accordance with the present invention. In these instances, different foundation and trend layers may be developed which are suitable for the particular product.

An illustrated method for displaying information related to a plurality of products includes the steps of displaying a first layer including a plurality of segments representing components of a first parameter; displaying a second layer over the first layer, the second layer including a plurality of segments representing components of a second parameter; and displaying indicia over the second layer representing a plurality of products.

In an illustrated embodiment, a price continuum layer is displayed over the second layer. The price continuum layer is based on the prices of displayed products currently being sold at selected retail locations.

In an illustrated embodiment, the method further includes providing a menu listing a plurality of companies and selecting companies from the menu of companies. The step of displaying indicia on the second layer includes displaying indicia related to products from selected companies. Illustratively, the indicia representing the plurality of products is coded to indicate which of the plurality of companies made the products.

Also in an illustrated embodiment, the method further includes providing a menu listing a plurality of price ranges and selecting at least one price range from the menu. The step of displaying indicia on the second layer includes displaying indicia related to products from the selected price ranges.

In another illustrated embodiment, the method further includes providing a menu listing a plurality of retailers and selecting at least one retailer from the menu. The step of displaying indicia on the second layer includes displaying indicia related to products available from selected retailers.

In a further illustrated embodiment, a system for displaying information related to a plurality of products includes a computer, a display coupled to the computer, and an input device coupled to the computer. The system also includes means for displaying a first layer including a plurality of segments representing components of a first parameter, for displaying a second layer over the first layer, the second layer including a plurality of segments representing components of a second parameter, and for displaying indicia over the second layer representing a plurality of products.

Additional features of the invention will become apparent to those skilled in the art upon consideration of the following detailed description of the presently perceived best mode of carrying out the invention.

### BRIEF DESCRIPTION OF THE DRAWINGS

The detailed description particularly refers to the accompanying figures in which:

FIG. 1 is a block diagram illustrating a computer system for implementing the present invention;

FIG. 2 illustrates a foundation layer of the present invention;

FIG. 3 is a graph illustrating example categories for a trends layer of the present invention;

FIG. 4 illustrates a trends layer overlaid on the foundation layer;

FIG. 5 illustrates a price continuum layer overlaid on the trends layer and the foundation layer; and

FIGS. 6-14 are screenshots illustrating operation of the apparatus and method of the present invention.

### DETAILED DESCRIPTION OF THE DRAWINGS

As discussed above, the present invention relates to a style and trend tracking software tool for use in product development, analysis or marketing. The software tool is useful to an industrial designer or other product developer to assist with the design process.

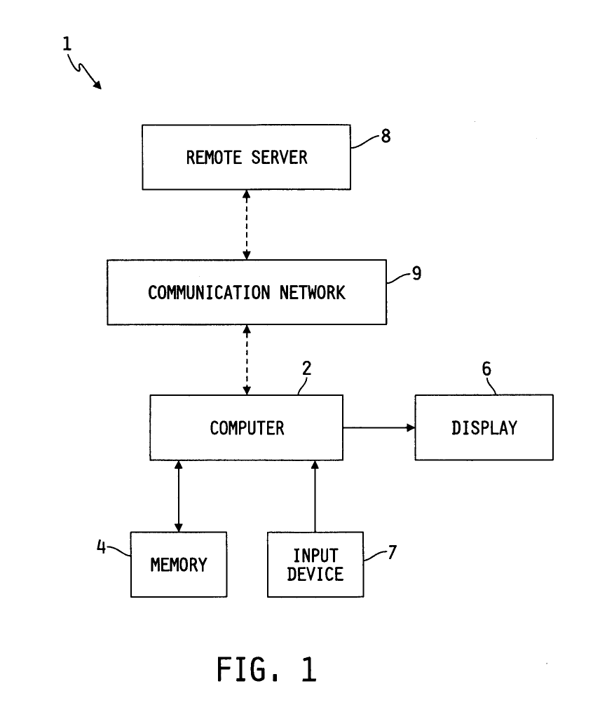

The present invention is illustratively implemented on a computer system 1 as shown in FIG. 1. The illustrative computer system 1 includes a computer 2 having a microprocessor and a memory 4 for storing data. Computer 2 is coupled to a display 6 and at least one input device 7. The input device 7 may illustratively be a keyboard, a mouse, a joystick, a voice recognition input, a touch screen, a pen or stylus based input or other suitable input device. The input device 7 permits a user to control operation of a software program in a conventional manner. The computer 2 may run a program and access data stored in its own memory 4. The system is a present invention and may also be implemented on a local area network (LAN) or a wide area network (WAN). Therefore, in another illustrated embodiment, the software and data may be accessed from remote server 8 using a suitable wireless or wired communications network 9 such as an Intranet, the Internet or cell phone transmission.

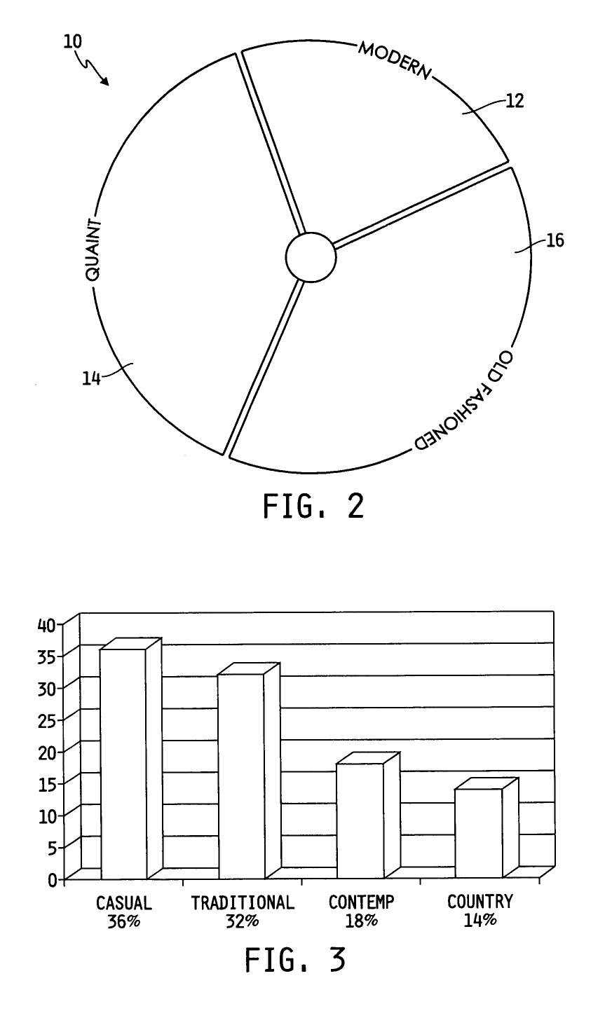

An illustrated embodiment of the present invention is built in four separate layers superimposed or overlaid on each other on the display 6. A foundation layer 10 is illustrated in FIG. 2. The foundation layer 10 for a household product design is illustratively derived from historical design cues, current housing stock, and current interior and exterior home preferences.

In the illustrated example, the foundation layer 10 includes a modern segment 12 for post 1950, a “quaint” segment 14 for 1900-1950, and an “old-fashioned” segment 16 for pre-1950. It is understood that determination of the foundation layer is somewhat subjective. The foundation layer can be broken into a greater number of segments or fewer number of segments depending upon a particular design application and the industry. The particular segments used in the illustrated foundation layer 10 are not required. The present illustrated embodiment relates to development of new products for homes, such as, for example, the development of new faucets. Therefore, the foundation layer as set forth in FIG. 2 is particularly suitable for the illustrated application for home product design.

In an illustrated example of the foundation layer 10 development process, information may be gathered using known sources such as The Detroit News' Survey of Residential Energy Consumption and/or the Cooper Marketing and National Family Opinion where about 10,000 consumers were interviewed.

Homes built in the 1970's and 1980's (representing about 25-30% of total housing stock) were not exterior design specific. Interior design styles for these homes tend to be casual, country and urban chic. Top new home exterior design plans vary depending on the region of the country.

For the illustrated embodiment, the foundation layer 10 is divided into three separate segments based on the percentages of home styles which are pre-1900, 1900-1950, and post-1950 as shown in FIG. 2. It is understood that different segments may be used, if desired. Major design cues for pre-1900 include: Baroque, Tudor & Jacobean, Early & Late Georgian, Colonial, Regency, Federal & Empire, and British & American Victorian. Major design cues for 1900-1950 include: Arts and Crafts, Art Nouveau, Edwardian, American Beaux Arts, and 20's & 30's. Major design cues for post-1950 include: Modern Movement and Beyond Modem.

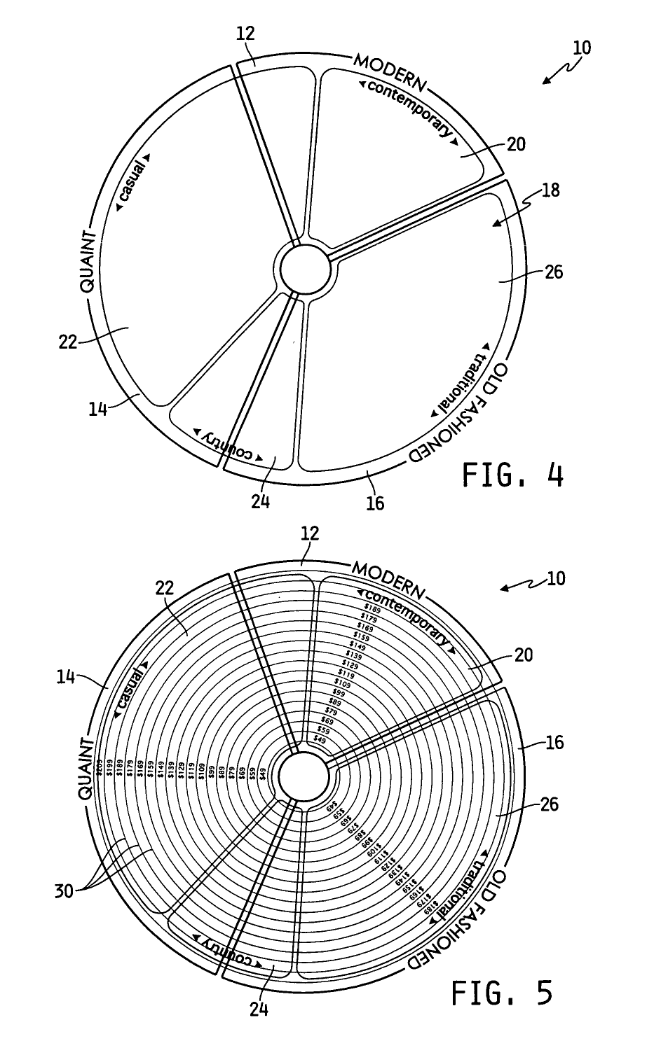

After the foundation layer 10 is complete, a trends layer 18 is illustratively superimposed or overlaid onto the foundation layer 10 as shown in FIG. 4. The trends layer 18 is illustratively derived from currently identified design trends based on information obtained from trade shows, the Internet and periodical research, or from other available industry services. The illustrative trends layer 18 categories are shown in FIG. 3. Because the illustrated example relates to products for homes, the trends illustratively relate to interior decorating styles. In the illustrated example, it was determined that casual style represented 35-40% of households, traditional style represented 30-35% of households, contemporary style represented 15-20% of households, and country style represented 10-15% of the households. This data is shown graphically in FIG. 3. In the illustrated example, trend layer categories may include the following:

Casual

Simple Refinement

Traditional

Sovereign Rule

Country

Country Sophisticate

Contemporary

Urban Chic

Retro Nation

Silver Screen

Mixed History

FIG. 4 illustrates the trends layer 18 as an overlay on the foundation layer 10. The trends layer 18 is illustratively color-coded and illustratively includes a contemporary segment 20, a casual segment 22, a country segment 24, and a traditional segment 26. In the illustrated example, the segments 20, 22, 24 and 26 are different colors to facilitate differentiation between the segments. Also in the illustrated example, the casual segment 22 overlaps the quaint segment 14 and the modern segment 12 of the foundation layer 10. The country segment 24 overlaps the quaint segment 14 and the old fashioned segment 16 of the foundation layer 10.

It is understood that the segment categories of trends layer 18 are subjective and may change depending upon the particular product being developed and the industry in which the software tool of the present invention is used. It is also understood that a greater or lesser number of segments may be used in accordance with the present invention. The particular segments used in the illustrated trends layer 18 are not required.

Next, the illustrated system includes a price continuum layer as shown in FIG. 5. Illustratively, various price ranges for products extend radially outwardly from a center of the display as shown in FIG. 5. The circular rings 30 identify equivalent price zones within each market segment. The price ranges are selected depending upon the particular price ranges for the products within the industry under consideration. The illustrated prices range from $49 to $209.

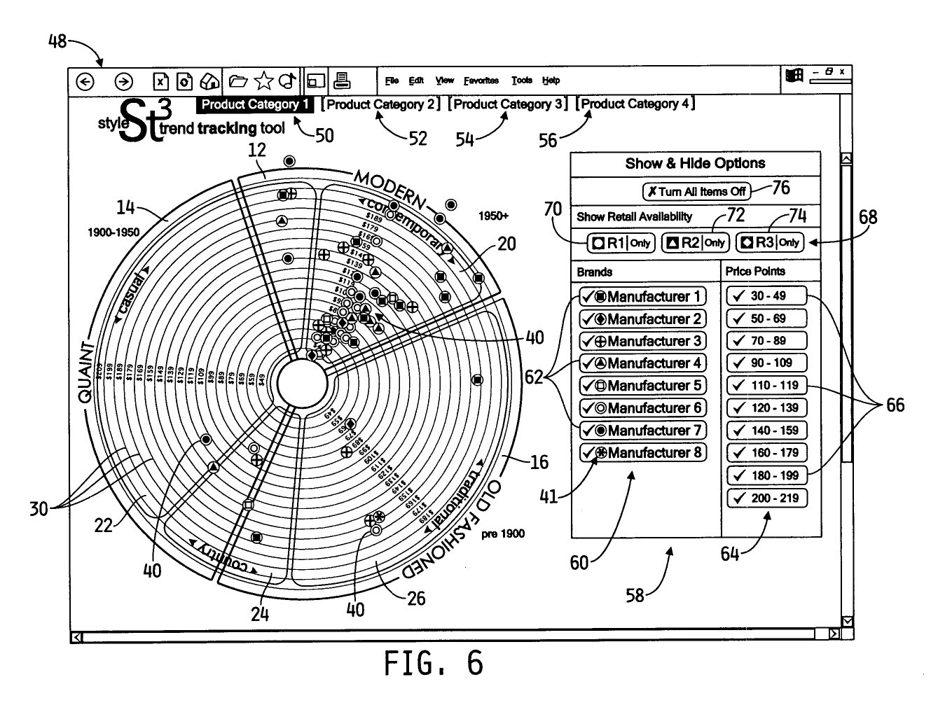

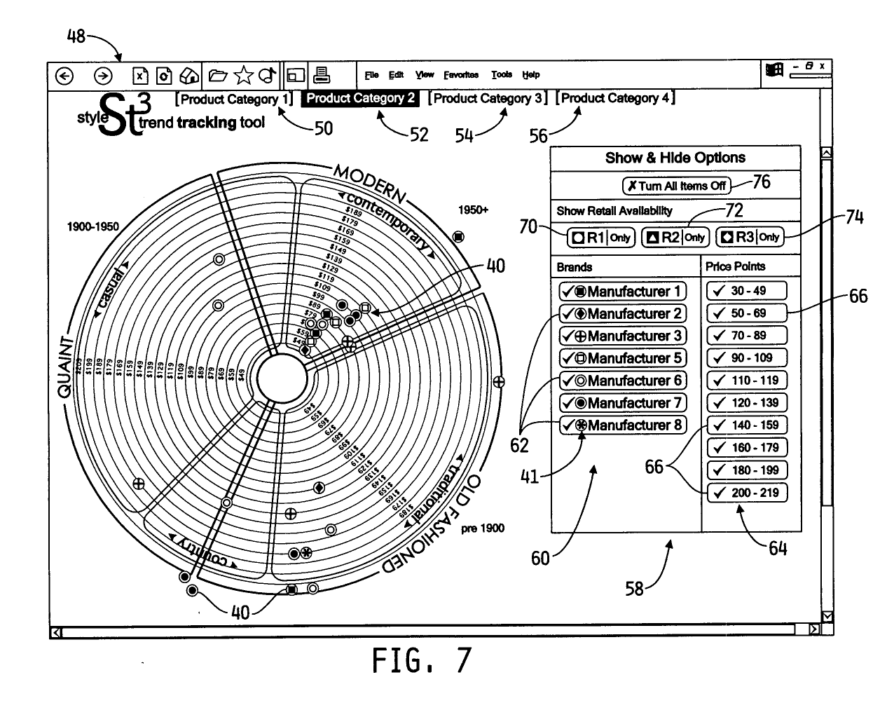

Next, a product mapping layer includes indicia related to a plurality of products. The indicia is illustratively a plurality of markers such as dots 40 representing mapped products which are overlaid onto the previous three layers. A company's products, as well as competitive product portfolios, may be displayed over the previous layers. In the illustrative embodiment, the four layers are positioned on a display screen 48 of display 6 to provide the design or analysis tool of the present invention. Features of the invention will become more apparent upon consideration of the description of the full system illustrated in images of an example display screen 48 shown in FIGS. 6-14.

FIG. 6 shows a product map for one example of the present invention. In the illustrated embodiment, product category menu selection buttons 50, 52, 54 and 56 are located at the top of the display screen 48. In FIG. 6, button 50 is selected, which is illustratively product category 1.

A selection box 58 illustratively allows a user to pick and choose between various product brands and price points to be displayed. In addition, the user can determine retail availability of the products. The selection box 58 illustratively includes a product brand or manufacturer selection section 60. Therefore, the tool of the present invention is used to map products from various manufacturers onto the visual display screen 48 on the computer 2. Illustratively, eight manufacturers 1-8 are shown in the drawings. It is understood that more or less manufacturers may be provided, as desired.

In the illustrated embodiment, the user clicks on selected buttons 62 to add and remove a manufacturer's products from the products being displayed on display screen 48. Each button 62 illustratively corresponds to a different company or manufacturer 1-8.

Selection box 58 further includes a price point selection section 64. Again, the user can click on various price point range buttons 66 to select or deselect items from particular price ranges to be displayed. In the illustrated embodiment a check mark on button 62 or 66 indicates that an item has been selected and an “X” indicates that an item is not selected.

The selection box 58 further includes a retailer selection portion 68. Illustratively, three different retailer buttons 70, 72, and 74 are shown for retailers R1, R2 and R3. In an illustrated embodiment, the retailers may include, for example, Home Depot, Lowe's and Menard's for certain product categories. By selecting one of the retail buttons 70, 72, 74, the tool displays those products available at the selected retailer on display screen 48.

The selection box 58 further includes a button 76, which permits the user to turn off (deselect) all of the items with the click of one button 76. It is understood that more or less buttons may be used in selection box 58, and that other ways of selecting items (such as drop down menus, etc.) may be used.

FIG. 7 shows the product map for all products when category menu button 52 is selected for product category 2. Similar product maps for all products within product categories 3 and 4 will be displayed when menu buttons 54 and 56, respectively, are selected.

All of the dots 40 on the displayed product map illustrate separate products offered by different manufacturers. The dots 40 provide an indication or map of the products within different segments of the foundation layer 10 and trends layer 18 to provide a visual market overview for the selected product category. In the illustrated embodiment, the product dots 40 are coded with different symbols or are color-coded to match coded dots 41 or colors associated with the various manufacturers 1-8 on buttons 62. Therefore, the user can quickly determine by visual inspection of the dots 40 which of the manufacturers, represented by coded dots 41 or colors on the buttons 62, manufactured the specific products illustrated by the dots 40. Symbols or colors of dots 40 illustratively match the symbols 41 or colors of company on selection buttons 62 to provide an indication of products made by that company.

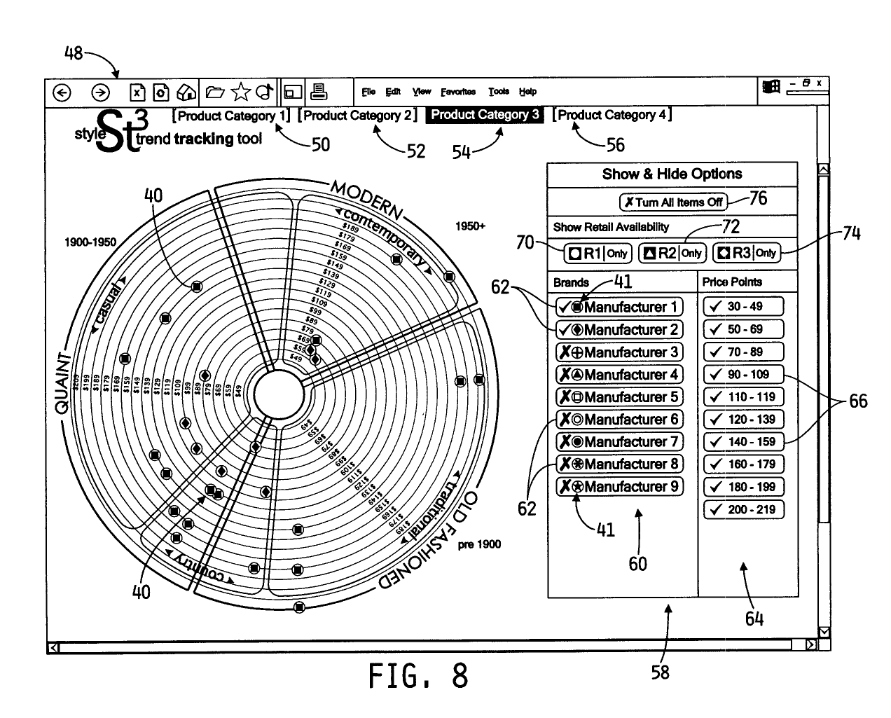

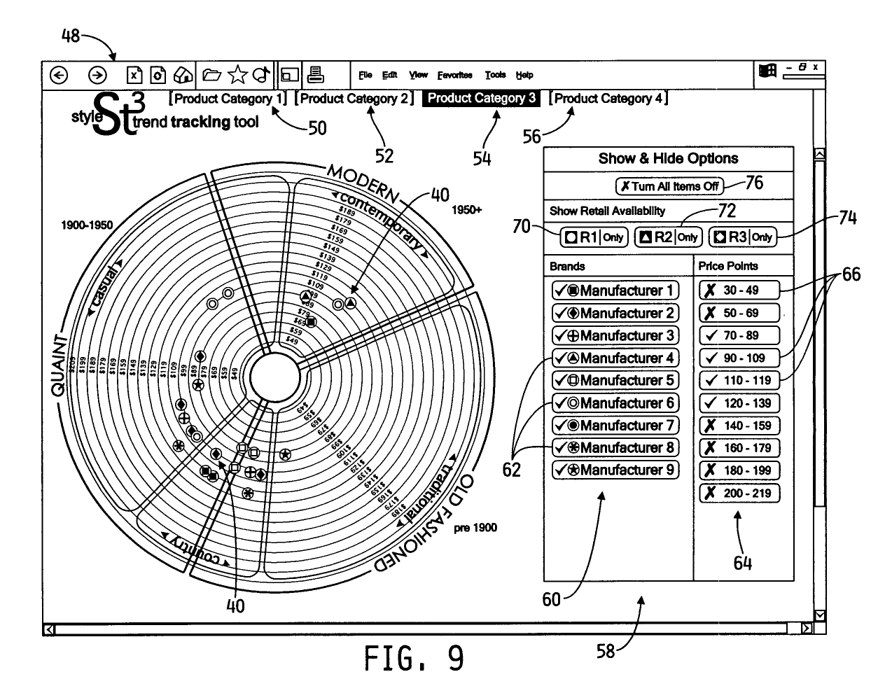

Operation of the system of the present invention is further illustrated in FIGS. 8-14. In FIGS. 8-14, product category 3 represented by button 54 is selected. For instance, in FIG. 8, only the top two manufacturer buttons 62 have been selected. The other brand buttons are turned off and marked with an “X.” Therefore, products of the first two companies, illustratively manufacturers 1 and 2, are displayed on the display screen 48. The selected brands 62 are marked with a check mark.

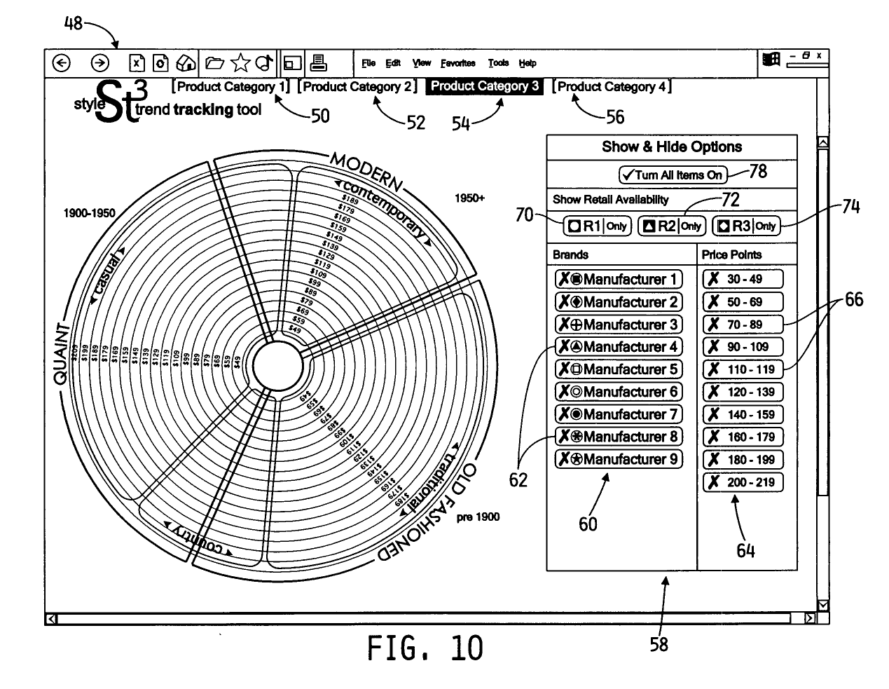

FIG. 9 illustrates the product display when several of the price points buttons 66 are turned off. Again, the price ranges selected are marked with a check mark, while the price ranges that are not selected are marked with an “X.” Therefore, products within the selected price ranges are displayed on display screen 48.

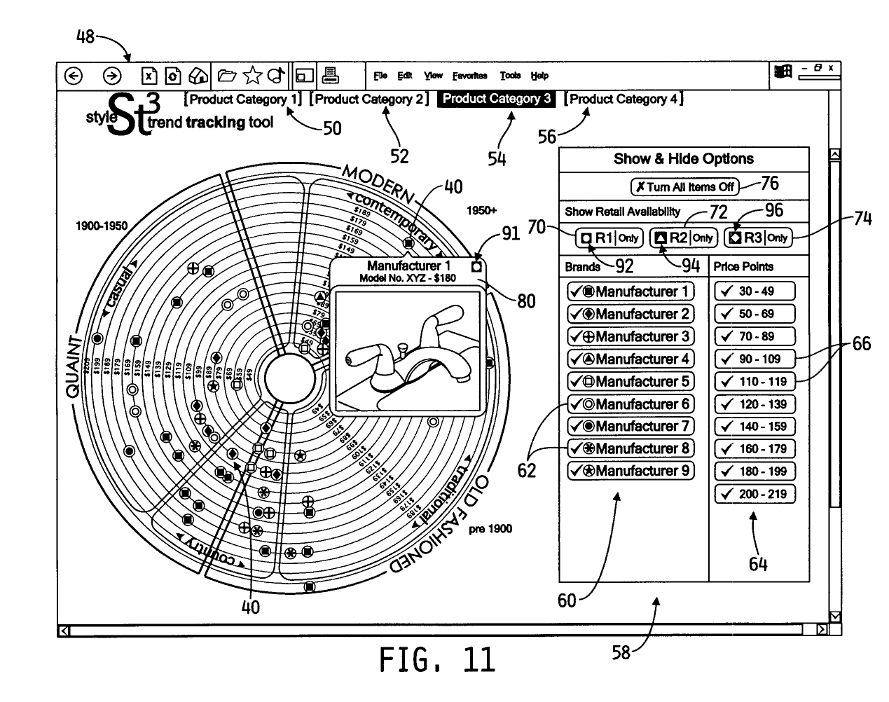

FIG. 10 discloses the tool with all of the items turned off. No product dots 40 are shown on the display screen 48 since all of the items are turned off. When all of the items are turned off, the selection box 58 includes a button 78 which will turn on all of the items again with a single click.

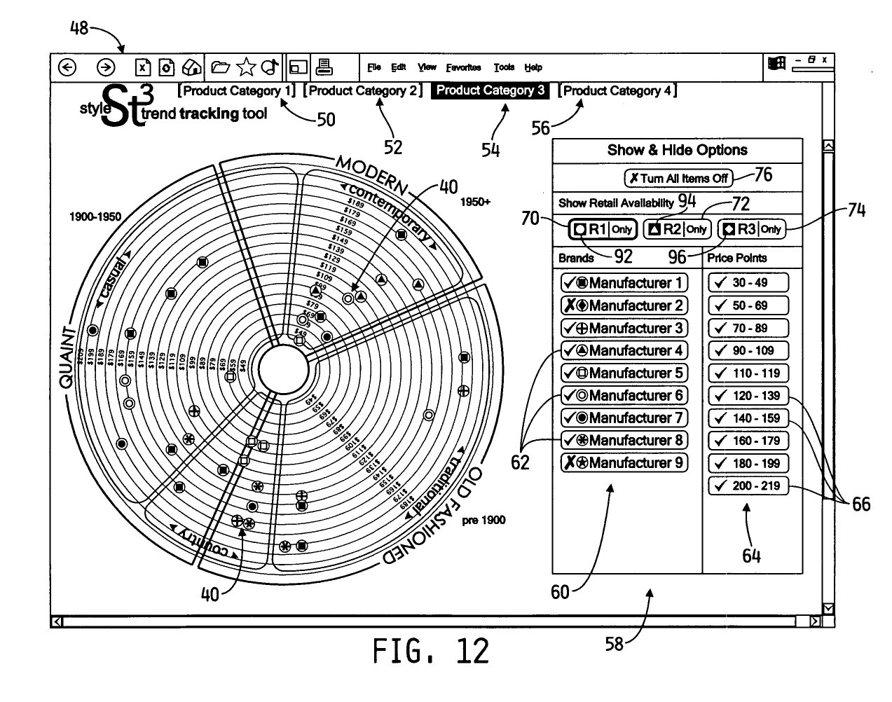

In the present invention, when the cursor is moved over a particular dot 40 using a mouse or other input device, the particular product referenced by the dot 40 automatically pops up in box 80 onto the display screen as illustrated in FIG. 11. This permits the user to quickly determine information about the product, such as model number, price, manufacturer, retailer, and an image of the product represented by the particular dot 40. A symbol 91 in box 80 matches symbol 92 in retailer box 70 to show that the selected product is available from retailer R1. In FIG. 11, the selected product shown in box 80 is a Modern, Contemporary product as indicated the by foundation layer 10 and trends layer 18 location.

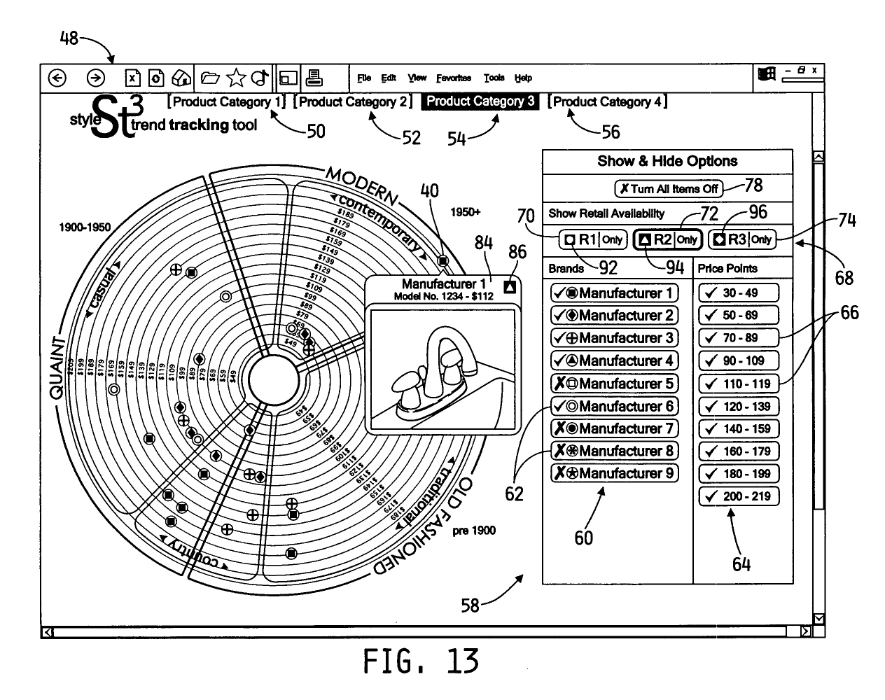

In another feature, those products available at particular retailers can be quickly determined. In FIG. 12, those products available at the retailer identified by the selected button 70 are displayed by clicking on the “only” button 70. In FIG. 13, those products sold by the retailer identified by the selected button 72 are displayed by clicking on button 72. FIG. 13 illustrates a pop-up box 84 located by a selected product dot 40. A color-coded marker or other symbol 86 in the pop-up box 84 matches the symbol 94 to show the retailer at which a particular product is available. In the example, the color or symbol 86 indicates that the selected product is only available at retailer R2 (represented by button 72 which matches the color or symbol 94).

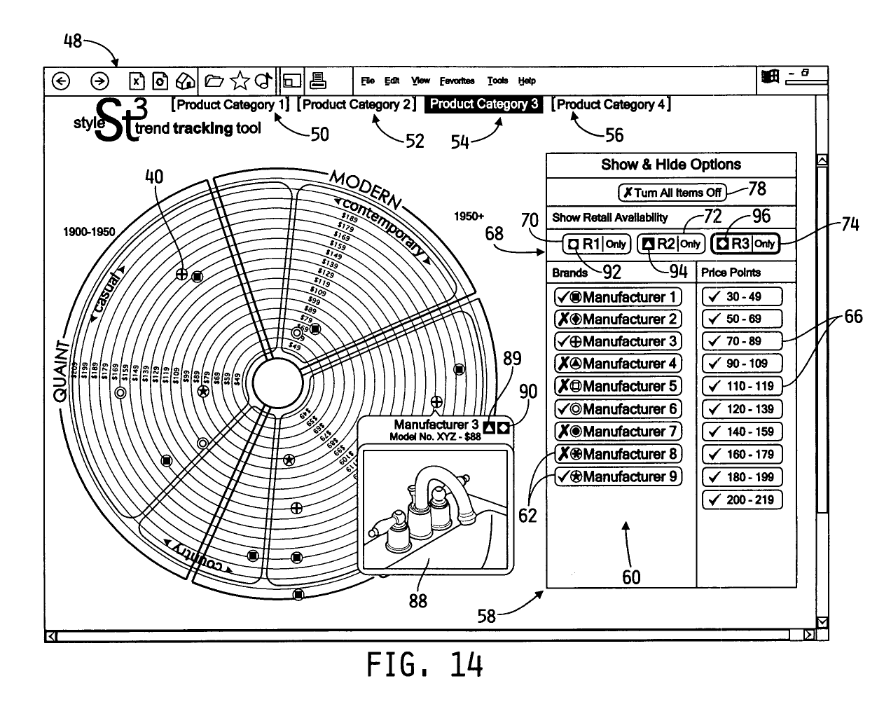

FIG. 14 illustrates the products displayed when retailer button 74 is selected. Again, another pop-up box 88 is shown. In this instance, two colored dots or symbols 89 and 90 shown in the pop-up box 88 item indicate that this particular product is available at both retailers R2 and R3. The buttons 62 marked with an “X” in FIGS. 12-14 indicate that products from these vendors are not available at the selected retailer.

It is understood that other display formats can be used in place of the circular display illustrated in the drawings. For instance, X-Y charts and graphs, or other 2D and 3D modeling may be used to display the information in a layered format discussed above.

The tool of the present invention is useful to an industrial designer or other product developer to assist with the design process. The tool of the present invention is also useful for product marketing. The tool can also be useful for product portfolio audits. The information related to the mapped products may include patent, trademark and other intellectual property information to assist companies in enforcement of their intellectual property and with product clearance studies related to competitor's products and intellectual property.

While the invention has been illustrated and described in detail in the drawings and foregoing description, such description is to be considered as exemplary and not restrictive in character. It is understood that only exemplary embodiments have been shown and described and that changes and modifications that come within the scope and spirit of the invention described in the following claims are desired to be protected.

What is claimed is:

1. A method for displaying information related to a plurality of products, the method comprising:
displaying a first layer including a plurality of segments representing components of a first parameter;
displaying a second layer over the first layer, the second layer including a plurality of segments representing components of a second parameter; and
displaying indicia over the second layer representing a plurality of products.

2. The method of claim 1, wherein the first layer segments are derived from at least one of historical design cues, current housing stock, current interior preferences, and current exterior home preferences.

3. The method of claim 1, wherein the second layer is a trends layer related to home interior design trends.

4. The method of claim 1, further comprising displaying a price continuum layer over the second layer, the price continuum layer being based on the prices of displayed products currently being sold at selected retail locations.

5. The method of claim 1, wherein the step of displaying indicia on the second layer representing a plurality of products maps a company's product information and competitive product information over on the first and second layers.

6. The method of claim 1, wherein the step of displaying indicia on the second layer representing a plurality of products includes displaying a plurality of markers, each marker representing a product.

7. The method of claim 1, wherein the first layer segments include a modern segment, a quaint segment, and an old-fashioned segment.

8. The method of claim 1, wherein the first and second layers are displayed in a circular shape display.

9. The method of claim 8, further comprising displaying price information on the second layer, the price information including a price continuum extending radially outwardly from a center of the display.

10. The method of claim 1, further comprising providing a menu listing a plurality of companies, selecting companies from the menu of companies, and wherein the step of displaying indicia on the second layer includes displaying indicia related to products from selected companies.

11. The method of claim 10, wherein the menu includes a plurality of selectable buttons related to the plurality of companies.

12. The method of claim 10 wherein the indicia representing the plurality of products is coded to indicate which of the plurality of companies made the products.

13. The method of claim 12, wherein a plurality of selectable menu buttons related to the plurality of companies are coded to match the indicia.

14. The method of claim 1, further comprising providing a menu listing a plurality of price ranges, selecting at least one price range from the menu, and wherein the step of displaying indicia on the second layer includes displaying indicia related to products from the selected price ranges.

15. The method of claim 1, further comprising providing a menu listing a plurality of retailers, selecting at least one retailer from the menu, and wherein the step of displaying indicia on the second layer includes displaying indicia related to products available from selected retailers.

16. The method of claim 1, further comprising selecting an indicia, and displaying further information related to the product represented by the indicia.

17. The method of claim 16, wherein the further information related to the product represented by the indicia is displayed automatically when a cursor is moved over a particular indicia by a user.

18. The method of claim 16, wherein the further information related to the product represented by the indicia is at least one of a model number, a price, a manufacturer, a retailer and an image of the product represented by the selected indicia.

19. The method of claim 16, wherein the further information related to the product represented by the indicia is displayed in a pop-up box.

20. A system for displaying information related to a plurality of products, the system comprising:
a computer;
a display coupled to the computer;
an input device coupled to the computer; and
means for displaying a first layer including a plurality of segments representing components of a first parameter, for displaying a second layer over the first layer, the second layer including a plurality of segments representing components of a second parameter, and for displaying indicia over the second layer representing a plurality of products.

21. The system of claim 20, wherein the computer accesses a remote server via a communications network.

22. The system of claim 20, wherein input device is one of a keyboard, a mouse, a joystick, a voice recognition input, a touch screen, a pen input, and a stylus input.

23. The system of claim 20, further comprising means for providing a menu listing a plurality of companies, and means for selecting companies from the menu of companies, and wherein the means for displaying indicia on the second layer displays indicia related to products from selected companies.

24. The system of claim 23, wherein the menu includes a plurality of selectable buttons related to the plurality of companies.

25. The system of claim 20, wherein the indicia representing the plurality of products is coded to indicate which of the plurality of companies made the products.

26. The system of claim 20, further comprising means for providing a menu listing a plurality of price ranges, and means for selecting at least one price range from the menu, and wherein the means for displaying indicia on the second layer displays indicia related to products from the selected price ranges.

27. The system of claim 20, further comprising means for providing a menu listing a plurality of retailers, and means for selecting at least one retailer from the menu, and wherein the means for displaying indicia on the second layer displays indicia related to products available from selected retailers.
